(19) United States
(12) Patent Application Publication
(10) Pub. No.: US 2026/0178817 A1
(43) Pub. Date: Jun. 25, 2026

(54) SEMANTIC CONTEXTS FOR LANGUAGE PROCESSING NEURAL NETWORKS

(71) Applicant: Composable Prompts Corp, New York, NY (US)

(72) Inventor: Eric Barroca, Tokyo-to (JP)

(21) Appl. No.: 18/999,544

(22) Filed: Dec. 23, 2024

(51) Int. Cl. G06F 40/166; G06F 40/30

(52) U.S. Cl. CPC G06F 40/166; G06F 40/30

(57) ABSTRACT

Methods, systems, and apparatus, including computer programs encoded on a computer storage medium, for obtaining, by a system that is connected between a client device and one or more external large language models (LLMs) that are each external to the system, a textual electronic document, inserting reference points at different locations within the textual electronic document, semantically processing the textual electronic document using a first language processing neural network with an instruction to identify different sub-portions of the textual electronic document that each correspond to a different semantic category, transforming the textual electronic document into multiple different smaller sub-documents, each complying with an input size limit of the external LLMs, receiving a document analysis request from the client device, identifying a particular smaller sub-document from among the multiple different smaller sub-documents for analysis, and providing the particular smaller sub-document as input to at least one of the external LLMs.

### BACKGROUND

This specification relates to processing data, and configuring machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that can transform a textual electronic document into a number of sub-documents independently of any structural elements of the textual electronic document, e.g., paragraphs, sections, pages, etc. In this specification, a textual electronic document refers to an electronic document including data that causes presentation of a set of textual content at a client device. An electronic document (which for brevity can be simply referred to as a document) does not necessarily correspond to a file. That is, a document may be stored in a portion of a file that holds other documents, in a single file dedicated to the document in question, or in multiple coordinated files.

In particular, the system is connected between a client device and one or more external large language models (LLMs) that are each configured to process prompts, e.g., directive instructions, and are associated with an input size limit. In some cases, the prompts relate to a context, e.g., supporting data provided to aid the model in responding to the prompt. The system of this specification can facilitate the targeted use of a portion of the textual electronic document as context for at least one of the one or more external LLMs in accordance with the input size limit of the external LLM, e.g., an input context window or length defining the number of input tokens that a particular LLM can process.

More specifically, the system can identify and provide one or more relevant sub-documents to an external LLM in response to a document analysis request. For example, the system can receive a question or statement that relates to the textual electronic document, and can identify and provide a particular sub-document from among the multiple different sub-documents as context to at least one of the external LLMs for processing. The system can then receive the response from one or more of the external LLMs.

According to a first aspect there is provided a method for obtaining, by a system that is connected between a client device and one or more external large language models (LLMs) that are each external to the system, a textual electronic document, inserting, by the system, reference points at different locations within the textual electronic document, semantically processing the textual electronic document using a first language processing neural network with an instruction to identify different sub-portions of the textual electronic document that each correspond to a different semantic category among multiple semantic categories, wherein the semantic processing is performed independent of structural boundaries of the textual electronic document, identifying, by the system and for each given sub-portion among the different sub-portions of the textual electronic document, a corresponding start reference point and a corresponding end reference point from among the inserted reference points, wherein a start of the given sub-portion is at a first location of the corresponding start reference point, and an end of the given sub-portion is a second location of the corresponding end reference point, transforming, by the system, the textual electronic document into multiple different smaller sub-documents, wherein each given smaller sub-document contains text of a given sub-portion among the multiple different sub-portions, and wherein each of the multiple different smaller sub-documents complies with an input size limit of the one or more external LLMs, receiving a document analysis request from the client device, and in response to receiving the document analysis request from the client device, identifying a particular smaller sub-document from among the multiple different smaller sub-documents for analysis, and providing the particular smaller sub-document as input to at least one of the one or more external LLMs.

In an example implementation, in response to receiving the document analysis request from the client device, identifying one or more additional particular smaller sub-documents of two or more additional textual electronic documents, providing the one or more additional particular smaller sub-documents of two or more additional textual electronic documents as input to at least one of the one or more external LLMs, and receiving, from the one or more external LLMs, an aggregate analysis of the particular smaller sub-document and the one or more additional particular smaller sub-documents.

In an example implementation, semantically processing the textual electronic document further includes, for each identified different sub-portion, processing the identified sub-portion using the first language processing neural network with an instruction to identify any additional different sub-portions of the identified sub-portion that each correspond to a different semantic category among multiple semantic categories.

In an example implementation, transforming the textual electronic document into multiple different smaller sub-documents by the system includes, for each given smaller sub-document, linking the given smaller sub-document and data specifying (i) the start reference point and the end reference point of the text of the given smaller sub-document and (ii) a given semantic category of the given smaller sub-document based on the semantic analysis of the text of the given smaller sub-document.

In an example implementation, linking data specifying the given semantic category to the given smaller sub-document includes associating a sub-document embedding of the given smaller sub-document with the given semantic category.

In an example implementation, the method further includes obtaining a document-level embedding representing the textual electronic document, and linking the textual electronic document and the multiple different smaller sub-documents corresponding with the textual electronic document based on a measure of similarity between the document-level embedding and the sub-document embeddings.

In an example implementation, identifying a particular smaller sub-document from among the multiple different smaller sub-documents for analysis includes determining respective measures of similarity between one or more request embeddings generated from the document analysis request and one or more of (i) the document-level embedding of the textual electronic document and, for each particular smaller sub-document, (ii) the sub-document embedding of the particular smaller sub-document.

In an example implementation, the method further includes selecting at least one smaller sub-document based at least on the respective measures of similarity.

In an example implementation, the at least one smaller sub-document is selected from a database including sub-document embeddings using a retriever model, and wherein each sub-document embedding has been generated by processing a respective sub-document from the identified one or more sub-documents using an embedding neural network.

In an example implementation, the method further includes identifying one or more additional particular smaller sub-documents of two or more additional textual electronic documents in response to receiving the document analysis request, wherein identifying the one or more additional particular sub-documents includes determining a respective first measure of similarity between the one or more request embeddings and each document-level embedding in the database, selecting one or more candidate textual electronic documents based on the respective first measures of similarity, for each candidate textual electronic document, determining respective second measures of similarity between the one or more request embeddings and each sub-document embedding corresponding with the candidate textual electronic document, and identifying the one or more additional particular smaller sub-documents of two or more additional textual electronic documents based on the respective second measures of similarity.

In an example implementation, the method further includes receiving one or more corresponding responses to the document analysis request from the at least one of the one or more external LLMs.

In an example implementation, the method further includes using the one or more corresponding responses to perform a task, and providing results of the task to the client device.

In another aspect, there is provided a system comprising one or more computers and one or more storage devices storing instructions that are operable, when executed by the one or more computers, to cause the one or more computers to perform the method of any one of the example implementation methods described.

In another aspect, there is provided a computer storage medium encoded with a computer program, the program comprising instructions that are operable, when executed by data processing apparatus, to cause the data processing apparatus to perform the method of any one of the example implementation methods described.

Particular embodiments of the subject matter described in this specification can be implemented so as to realize one or more of the following advantages.

The system of this specification provides for the conversion of a textual electronic document into multiple different sub-documents that each correspond with a semantic category and can provide one or more of the sub-documents to an external LLM as context for a document analysis request. In particular, the system can transform the textual electronic document into semantically-comprehensive sub-documents by identifying semantic categories that are independent of structural textual breaks, e.g., line breaks, paragraph breaks, or periods.

By allowing for the targeted identification of a relevant sub-document as context for an external LLM, the system can reduce the computational resources necessary to process an input with the LLM to receive a response to the document analysis question. In particular, in contrast to providing the entire textual electronic document to be processed as a long context, the system can identify one or more sub-documents that are relevant to the request and provide the sub-documents to the external LLMs for processing. While some LLMs are configured to support the processing of long contexts, in practice, processing the entirety of a long context is not generally required to respond to the document analysis request and decreases the efficiency of the response generation of the LLM.

In addition, processing the entire textual electronic document is often not practical since the size of the textual electronic document can exceed the input size of the LLM, e.g., the number of allowable input tokens that the LLM can process. While other approaches to identifying and providing a smaller context to an LLM involve chunking the input into sub-portions based on structural textual breaks (e.g., paragraph breaks, sentence breaks, page breaks, n-gram breaks, or other delineations of the content that are based on the structure of the document), providing structural chunks to an LLM is not an efficient use of the input context window since requests usually relate to a complete idea, e.g., a semantic category, that is often defined independently of structural textual breaks. By transforming the textual electronic document into semantically-comprehensive sub-documents and identifying the relevant sub-documents for use in the input context, the system can provide tailored inputs to the LLM based on the document analysis request. The system can therefore decrease the computational resources necessary to generate a response and also provide for more robust and accurate responses to the document analysis request since the input includes a semantically-comprehensive context.

A technical problem overcome by the solutions presented in this specification is the problem of how to effectively and accurately use machine learning models to evaluate, analyze, or otherwise process documents that are larger (e.g., have more tokens) than the machine learning models are capable of accepting as a single input. This problem is solved, for example, by semantically chunking the document into smaller sub-documents such that the relevant contexts of the larger document are maintained in the smaller sub-documents. This enables the machine learning models to operate on the smaller sub-documents, which are within the size limits of the machine learning models and still maintain the relevant context for evaluation. Furthermore, the semantic chunking is done in a manner such that the portions of the document corresponding to each of the sub-documents can be tracked, which allows the original document to be recreated based on the sub-documents. Thus, output of the machine learning models generated based on a given sub-document can accurately reference the portion of the complete document to which the output is relevant. Still further, the present solutions enable relevant outputs to be generated by the machine learning models in response to requests/instructions provided to the machine leaning models based on processing of fewer than all of the sub-documents because only those sub-portions of the document that are relevant to the requests/instructions need to be evaluated by the machine learning models. In this way, the amount of data needed to be processed by the machine learning models is reduced relative to inputting the entire document into the machine learning models. This also reduces the latency of obtaining outputs from the machine learning models. In at least these ways, the presently described and claimed solutions improve the functioning of a machine learning system itself.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a system diagram of an example LLM request management system that connects a client device and one or more external LLMs.

FIG. 2 is a system diagram of example semantic sub-document identification subsystem.

FIG. 3 is a flow diagram of an example process for transforming a textual electronic document into smaller sub-documents for use as context for an LLM.

FIG. 4 illustrates an example of a computing device and a mobile computing device that can be used to implement the techniques described here.

Like reference numbers and designations in the various drawings indicate like elements.

### DETAILED DESCRIPTION

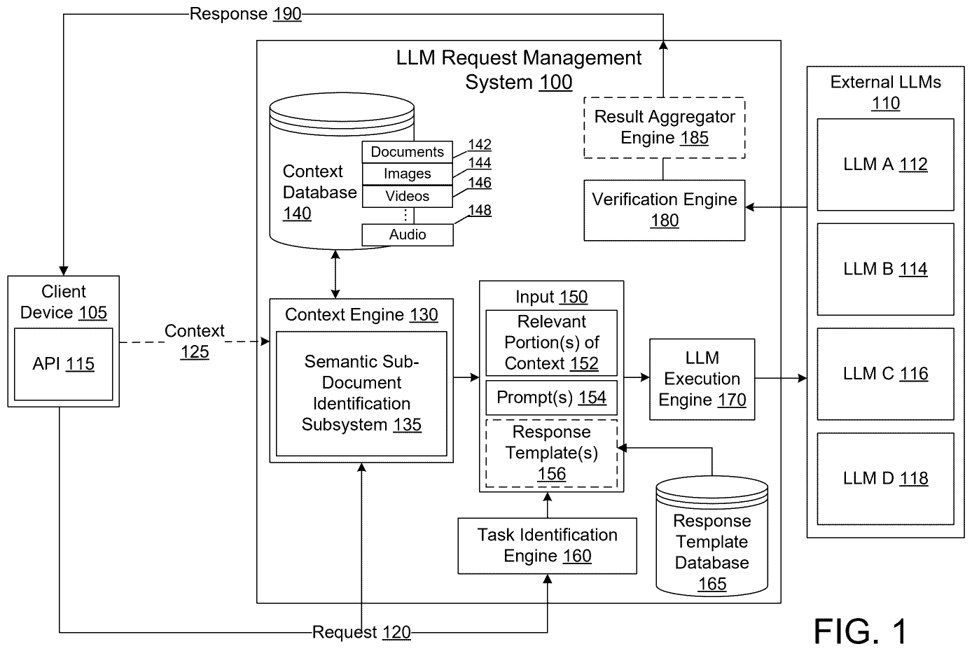

FIG. 1 shows an example LLM request management system 100. The LLM request management system 100 is an example of a system implemented as computer programs on one or more computers in one or more locations in which the systems, components, and techniques described below are implemented.

The LLM request management system 100 can connect a client device 105 and one or more external large language models (LLMs) 110. In particular, the system 100 can receive a request 120 from the client device 105, can determine an execution strategy for the request 120, and can provide for the configuration of an input 150 to at least one of the one or more LLMs 110 based on the execution strategy for the request 120, e.g., using at least one of the one or more external LLMs 110. As an example, the client device 105 can be a server, a laptop, a tablet computer, a desktop, or a mobile device. As another example, the client device 105 can be a wearable device, e.g., a smart-watch, or an internet of things (IoT) device.

Each LLM in the external LLMs 110, e.g., LLM A 112, LLM B 114, LLM C 116, and LLM D 118, can have a recurrent neural network architecture that is configured to sequentially process the contents of an input, e.g., a prompt, and trained to perform next element prediction, e.g., to define a likelihood score distribution over a set of next elements. More specifically, each LLM can be a transformer-based model, e.g., an encoder-decoder transformer, an encoder-only transformer, or a decoder-only transformer, that is configured to perform parallel processing of the contents of the multimodal input using a multi-headed attention mechanism. In particular, each large language model can be configured to process a sequence of input tokens and to predict a sequence of output tokens using a likelihood score distribution over a set of next elements based on the previously predicted output tokens.

In particular, the external LLMs 110 can be implemented with the same neural network architecture or with different neural network architectures. For example, LLM A 112 and LLM B 114 can be implemented with a first architecture, e.g., a Generative Pretrained Transformer (GPT) architecture, LLM C 112 can be implemented with a second architecture, e.g., a Text-to-Text Transfer Transformer (T5) architecture, and LLM D 118 can be implemented with a third architecture, e.g., a Bidirectional Encoder Representations from Transformer (BERT). As another example, a subset of the LLMs in the external LLMs 110 can have been finetuned from a foundational model for particular tasks in a mixture-of-experts model.

In some cases, one or more of the external LLMs 110 are multi-modal LLMs, e.g., that are configured to process one or more of a text modality, an image modality, an audio modality, or a video modality. For example, the external LLMs 110 can include a vision transformer, a contrastive language-image pretraining (CLIP) model, or a DALL-E model.

More specifically, the system 100 can configure an input 150 to one or more of the external LLMs 110 using the request 120. In particular, the system 100 can determine an execution strategy to execute the request 120 using the external LLMs 110. More specifically, the system 100 can determine one or more prompts 154 from the request 120, provide for the design of response templates 156 as example output formatting for the LLMs 110, and extract relevant data from any context 125 provided with the request 120. The system 100 can then route the input 150 to one or more of the external LLMs 110.

For example, the system 100 can receive a request 120 and, in some cases, a context 125 from the client device 105, e.g., by way of an applied programming interface (API) 115, for processing using an LLM. For example, the API 115 can enable a user, e.g., the user of the client device 105, to input requests and content to the system as context 125 for the request 120. As an example, the API 115 can be provided to the user over a network, e.g., the internet.

In the case that the system 100 receives a context 125, the context 125 can be, e.g., a text, a book, a legal document, a webpage, etc. As another example, the context 125 can be an image input, an audio input, or a video input. In this case, the request 120 can include a directed instruction that relates to the context 125. As an example, the request 120 can include a direction to identify “What are the themes of this media?” for an image or video context, or a list of corresponding text analysis questions for a textual electronic document, e.g., a legal contract.

In this case, the system 100 can process the context 125 using a context engine 130. In particular, the system 100 can process the context 125 to extract relevant associated data from the context 125, e.g., metadata that can facilitate the use of the context 125 in the input 150 to the LLMs 100. Additionally, the engine 130 can generate a context identifier for the context 125, e.g., to facilitate the identification of the context 125 in a data storage location.

In the particular example depicted, the system 100 can then maintain the context 125 and associated data in a context database 140. As an example, the context database 140 can include structured data, e.g., tables, that correspond with different context types, e.g., a documents table 142, an images table 144, a videos table 146, an audio table 148, etc.

For example, each table in the database 140 can be indexed using the context identifier generated by the context engine 130. In particular, in response to a request 120 that pertains to the context 125, e.g., that does not include the context 125 or includes a previously processed context 125, the system 100 can use the context identifier to identify the context 125 from the database 140. The system 100 can then include the context 125 or one or more relevant portions of the context 125 in the input 150 to the external LLMs 110.

In some cases, the entire context 125 can be included in the input 150 and processed by an LLM in the external LLMs 110. In other cases, the entire context 125 is too large to be included in the input 150 and processed by an LLM in the external LLMS 110. More specifically, each LLM of the external LLMs 110 is associated with an input size limit, e.g., a context window or length defined by the number of input tokens that the LLM is configured to process. While some LLMs are configured to support the processing of long contexts, e.g., contexts of 1-2 million tokens, in practice, processing an entire long context decreases the efficiency of the response generation from an LLM, and is generally not required, e.g., since not all of the context 125 is always relevant to respond to the request 120. Moreover, the users of an LLM, who are usually different from the entity that developed the LLM, are not in control of the size constraints of the LLM, and are generally required to operate within the size constraint of any given LLM that is developed by a third party. As such, it is common for the size of an entire document to exceed the size constraints of the LLM. The techniques of this specification are provided to work within the size constraints while still achieving an accurate analysis of the input and an accurate output.

In particular, the system 100 can provide for the identification of the relevant one or more portions of the context 152 for the input 150 to the one or more external LLMs 110, e.g., in the case that the context 125 is a long context. As a particular example, in the case that the context 125 is a textual electronic document, the content processing engine 130 can use a semantic sub-document identification subsystem 135 to identify different sub-portions of the textual electronic document as semantically-comprehensive sub-documents.

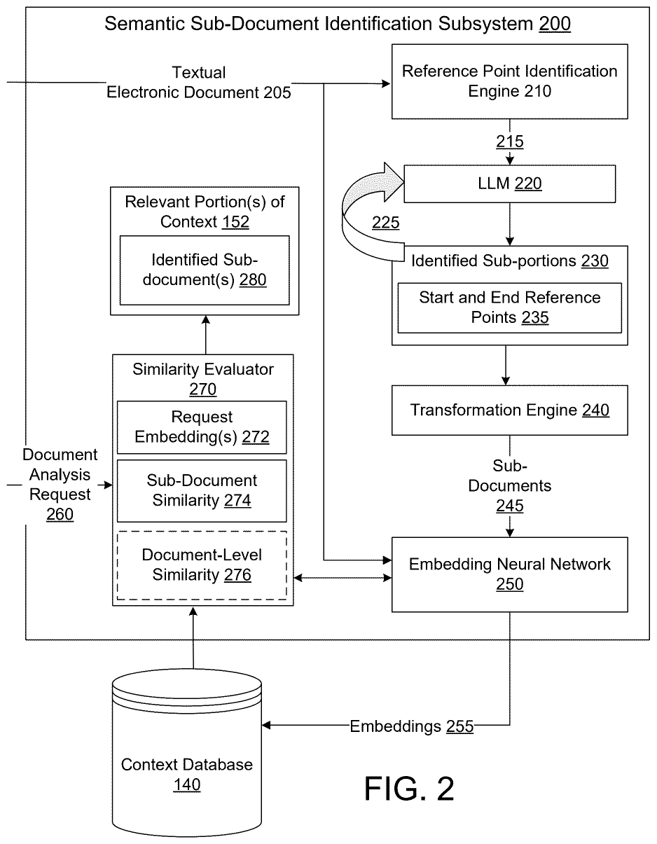

In this context, semantically-comprehensive refers to sub-portions of the textual electronic document that can be considered as the same semantic category. In particular, the system 100 can identify semantic categories independently of structural textual breaks included in the textual electronic document, e.g., paragraph breaks, sentence breaks, page breaks, n-gram breaks, or other delineations of the content that are based on the structure of the document, and can transform the textual electronic document into multiple different sub-documents based on the semantic categories. An example semantic sub-document identification subsystem 135 will be described in more detail with respect to FIG. 2.

In this case, the system 100 can maintain the textual electronic document and the corresponding sub-documents in the content database 140, e.g., for use as the relevant portion(s) of context 152 in the input 150.

The input 150 can include the relevant portion(s) of the context 152 and one or more prompt(s) 154 corresponding with the request 120. In particular, the system 100 can process the request 120 to determine one or more prompts 154, e.g., directive instructions to complete a particular task corresponding with the request 120, using a task identification engine 160. In this case, each task identified by the engine 160 can be included in a separate prompt. As an example, the task identification engine 160 can process the request 120, determine one or more tasks from the request 120, and generate one or more prompts 154 corresponding with the request. As another example, the engine 160 can process the request 120, decompose the request 120 into a set of sub-requests, and determine respective prompts 154 for each of the sub-requests.

For example, the request 120 can be decomposed into one or more tasks for a particular LLM, e.g., as a sequence of prompts in a chain-of-thought framework that decomposes a complex task into a sequence of related sub-tasks that an LLM can consecutively perform to effectively complete the complex task. As another example, the request 120 can be decomposed into tasks that each correspond with different finetuned LLMs, e.g., to take advantage of a mixture-of-experts model included in the external LLMs 110.

In some cases, the input 150 can additionally include one or more response template(s) 156, e.g., an example of the desired structure for the output in response to the prompt(s) 154. As an example, a response template for a particular prompt can include a rephrasing of the prompt, a main response, a summary of the response, and suggested next steps with respect to how the prompt relates to the response. In the case that the task identification engine 160 has decomposed the request 120 into a sequence of prompts in a chain-of-prompt framework, the system 100 can include respective response templates 156 for each of the prompts 154 in the sequence of prompts that facilitate the consecutive prompting of an LLM.

For example, the system 100 can receive the response template(s) 156 from the client device 105, e.g., by way of the API 115. In particular, the system 100 can provide an API 115 that allows for the configuration of a response template 156 for the request 120. In this case, a user of the client device 105 can specify a particular response template 156 for the request 120.

As another example, the system 100 can identify one or more response template(s) 156, e.g., from previously used response template(s) maintained in a response template database 165. More specifically, the system 100 can store previously received response templates with associated data indicating the purpose of the template in the database 165. In some cases, the system 100 can use the LLMs 110 to generate response templates, e.g., by prompting one or more of the external LLMs 110 to generate a response template for a given prompt, and storing the response templates in the database 165.

After determining the prompt(s) 154, relevant portion(s) of context 152, and response template(s) 156 necessary to respond to the request 120 as the input 150, the system 100 can process the input 150 using an LLM execution engine 170 and provide the input 150 to at least one of the external LLMs 110. For example, the LLM execution engine 170 can include a router that routes respective jobs for the input 150, where each job includes inputting corresponding relevant portion(s) of context 152, a prompt from the prompt(s) 154, and, in some cases, a response template from the response template(s) 156 to an external LLMs 110.

In particular, the LLM execution engine 170 can determine the execution strategy for the input 150, e.g., based on any relationships in the prompt(s) 154. As an example, the engine 170 can identify whether any of the one or more prompt(s) 154 can be executed parallel, e.g., by providing independent prompt(s), e.g., with corresponding context 152 and response template 156, to separate external LLMs 110. As another example, the engine 170 can determine whether a particular LLM in the external LLMs 110 is better-suited to perform the task represented by a particular prompt, e.g., due to the particular LLM having been specialized for the task through finetuning. In this case, the engine 170 can provide the particular prompt to the particular LLM for the specialized task.

As yet another example, the engine 170 can designate whether any of the one or more prompt(s) 154 should be executed by multiple LLMs. As an example, the engine 170 can provide an additional input to the multiple LLMs to indicate that the LLM is part of a multiple-participant processing job for the prompt and to request that each of the multiple LLMs additionally process the generated results from all of the participating LLMs in the multiple-participant processing job to generate an indication of the value of the responses, e.g., by voting on a best response or assigning a score to the responses.

The system 100 can then receive the one or more response(s) from the LLMs 110 corresponding to the input 150. In particular, the system 100 can verify the completion of the execution strategy for the request 120 using a verification engine 180. For example, the verification engine 180 can determine whether a response was received for each of the prompt(s) 154 in the input 150. In the case that any response is missing, the system 100 can re-execute the one or more prompt(s) corresponding with the missing responses. As another example, in the case that the prompt(s) 154 were accompanied by a response template(s) 156 in the input 150, the verification engine 180 can determine whether the responses received adhere to the relevant response template(s) 156.

The system 100 can also use the verification engine 180 to provide for workflow monitoring regarding inputted requests 120. For example, the verification engine 180 can log data regarding the responses received for different inputs 150. As an example, the system 100 can analyze the data, e.g., to support online improvement of the system, or to provide a user of the client device 105 with information regarding which execution strategies were most effective for responding to the request 120.

In the case that the system 100 receives a single response from the external LLMs 110 and verifies the response with the verification engine 180, the system 100 can provide the response 190 to the client device 105. In the case that the system 100 receives multiple responses from the external LLMs 110, after verifying the responses with the engine 180, the system 100 can process the responses using a result aggregator engine 185, e.g., to synthesize the results. In this case, the result aggregator can combine the responses into an aggregated response and provide the aggregated response to the client device 105 as the response 190.

FIG. 2 is a system diagram of example semantic sub-document identification subsystem. For example, the semantic sub-document identification subsystem 135 of the LLM request management system 100 of FIG. 1 can be implemented as the example semantic sub-document identification subsystem 200.

In the particular example depicted, the subsystem 200 can receive a textual electronic document 205, defined above. For example, the textual electronic document 205 can be a long-form text file, e.g., a contract, an essay, technical documentation, a court case filing, an annual report, or a script. As an example, the system 100 can receive the textual electronic document 205 as context from a client device and can use the semantic sub-document identification subsystem 200 to process the textual electronic document 205 to identify multiple different sub-documents of the textual electronic document 205 that each correspond with a different semantic category.

In some cases, the subsystem 200 can additionally determine whether the textual electronic document 205 can be segmented into multiple different sub-documents. In this case, the subsystem 200 can receive an indicator that the textual electronic document 205 includes structured text, or can process the textual electronic document 205 to identify whether the text is structured, e.g., using a textual segmentation model (not pictured) that has been trained on a document classification task to identify whether or not a document 205 is structured.

In the case that the subsystem 200 includes a textual segmentation model, the textual segmentation model can have any appropriate machine learning architecture, e.g., a neural network, that can be configured to process a textual electronic document and generate a binary indicator of whether or not the document is structured. In particular, the textual segmentation model can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

For example, the subsystem 200 can insert reference points at different locations into the textual electronic document 205, e.g., using a reference point identification engine 210. In particular, the subsystem 200 can add reference points to aid in the identification of the different sub-portions of the document 205 that are included in each sub-document. As an example, the subsystem 200 can enumerate line numbers for each line of the textual electronic document 205 and insert the line numbers into the document 205 as the reference points.

The subsystem 200 can then process (e.g., semantically) the textual electronic document with the reference points 215 using an LLM 220, e.g., a transformer-based encoder-only, decoder-only, or encoder-decoder LLM as is described with respect to FIG. 1, with an instruction to identify the different sub-portions 230 of the document 215 that correspond to a different semantic category. In this context, a semantic category can be a unifying idea, e.g., a topic, that corresponds with each of the identified sub-portions. As an example, the semantic categories can include multiple structural boundaries of the textual electronic document, e.g., multiple paragraphs, even across sections, or grouped sections. In particular, the subsystem 200 can identify: (i) section one to section two, tenth paragraph, (ii) section two, eleventh paragraph to section 4, and (iii) section four to the third paragraph of section six continued as sub-portions corresponding to different semantic categories.

In particular, the subsystem 200 can instruct the LLM 220 to generate a mapping between each identified sub-portion 230 and the corresponding start reference point and end reference point 235 that define each sub-portion, e.g., the line numbers. As an example, the LLM 220 can output a response, e.g., for the example given above as (i) lines 1-44, (ii) lines 45-139, and (iii) lines 140-203.

In some cases, the subsystem 200 can additionally process each of the identified different sub-portions 230, e.g., (i) section one to section two, tenth paragraph, (ii) section two, eleventh paragraph to section four, and (iii) section four to the third paragraph of section 6, using the LLM 220 to identify any additional different sub-portions that correspond to a different semantic category. For example, the subsystem 200 can process (i) section one to section two to identify additional sub-portions of (i), e.g., (1) subsection 1.1-1.3, second paragraph and (2) subsection 1.3, second paragraph to subsection 1.6 with corresponding (1) line numbers 1-27, and (2) 27-44. As a further example, the subsystem can process (1) and (2) using the LLM 220 to identify any additional sub-portions of (1) and (2).

In particular, the subsystem 200 can iteratively process each of the identified different sub-portions 230 and any additional different sub-portions using the LLM 220, e.g., as is represented by the arrow 225. More specifically, the subsystem 200 can determine a hierarchy of sub-portions according to a parent-child relationship between the identified sub-portion and any additional different sub-portions, after iteratively processing each of the identified different sub-portions and any additional different sub-portions.

In some cases, the subsystem 200 can iteratively process each of the identified different sub-portions a predetermined number of times, e.g., two times, three times, ten times, etc. In other cases, the subsystem 200 can determine whether or not to process the sub-portion in an additional iteration based on whether the identified sub-portion satisfies a criterion, e.g., with respect to an input size limit, e.g., an input context window or length defining the number of input tokens that the LLM can process, of at least one of the external LLMs. For example, in the case that a sub-portion is larger than the input size limit, the subsystem 200 can continue to iteratively process the sub-portion to identify any additional sub-portions, e.g., until the sub-portions satisfy the input size limit.

After identifying the sub-portions 230 and corresponding start and end reference points 235, the subsystem 200 can process the identified start and end reference points 235 to transform the textual electronic document with reference points 215 into multiple different sub-documents 245, e.g., using a transformation engine 240. For example, the transformation engine 240 can transform the textual electronic document with reference points 215 into multiple smaller sub-documents by segmenting the textual electronic document 215 into sub-documents that each contain the text of an identified sub-portion 230, e.g., by defining the start and the end of the sub-document using the start and end reference points 235.

The transformation engine 240 can additionally link the sub-documents to data specifying the start and end reference points 235 and the given semantic category of the sub-document, e.g., based on semantic analysis of the text. In particular, the subsystem 200 can additionally instruct the LLM 220 to generate the semantic category of the identified sub-portions 240. As an example, the subsystem 200 can link each sub-document to the respective semantic category by associating an embedding of the sub-document with the semantic category.

In the particular example depicted, the subsystem 200 can process each of the sub-documents 245 using an embedding neural network 250 to generate corresponding sub-document embeddings. For example, the embedding neural network 250 can be an encoder neural network that is configured to process a document, e.g., a sub-document, to generate an embedding of the document in a higher-dimensional embedding space. For instance, the embedding neural network 250 can have any appropriate machine learning architecture. In particular, the embedding neural network 250 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

In some cases, the subsystem 200 can additionally process the textual electronic document 205 using the embedding neural network 250 to generate an embedding of the textual electronic document. In this case, the subsystem 200 can associate the textual electronic document 205 and the multiple different smaller sub-documents 245 corresponding with the textual electronic document 205 using the embeddings 255, e.g., based on a measure of similarity, e.g., a cosine similarity metric, a Euclidean distance metric, a dot product similarity, or a Kullback-Leibler divergence, between the document-level embedding and the multiple different smaller sub-document embeddings.

In particular, the subsystem 200 can associate the document and corresponding sub-documents in the context database 140, e.g., by linking the identifier of the textual electronic document 205 to the embeddings 255. As an example, the context database 140 can maintain a separate embedding table for textual electronic document embeddings, and the embedding table can be configured to represent each textual electronic document 205 as a row, e.g., by including the document-level and corresponding sub-document embeddings as different column entries per the row. The subsystem 200 can then use the embeddings 255 to identify the relevant portion(s) of context 152 for responding to a request, e.g., a document analysis request that relates to the textual electronic document 205.

More specifically, in response to receiving a document analysis request 260, e.g., a request that relates to the textual electronic document 205, the subsystem 200 can identify one or more sub-document(s) as relevant to responding to the document analysis request 260. In particular, the subsystem 200 can process the request 260 using a similarity evaluator 270. The similarity evaluator 270 can use the embeddings 255 and one or more request embeddings 272 to identify the sub-document(s) 280 that are relevant to the document analysis request 260.

For example, the subsystem 200 can process the document analysis request 260 to generate one or more request embeddings 272 that correspond with the request 260, e.g., using the embedding neural network 250. As another example, the engine 270 can obtain the one or more request embeddings 272, e.g., as input to the subsystem 200.

In particular, the similarity evaluator 270 can compute one or more similarity measures between the request embedding(s) 272 and the embeddings 255 in the context database 140 in order to identify the sub-document(s) 280. As an example, the similarity evaluator 270 can then select the sub-document with the highest determined measure of similarity as the identified sub-document 280. As another example, the similarity evaluator 270 can select the top N sub-documents as the sub-documents 280 with the N highest measures of similarity.

The similarity evaluator 270 can compute the sub-document similarity 274 or both the sub-document similarity and the document-level similarity 276. In the case that the document analysis request 260 is received in concert with the textual electronic document 205, e.g., as part of the same or consecutive inputs to the system, the similarity evaluator 270 can evaluate the sub-document similarity 274 between the request embedding(s) 272 and each sub-document embedding generated for the textual electronic document 205. In this case, the subsystem 200 does not need to identify the relevant textual electronic document 205 for the request 260.

In contrast, in the case that the document analysis request 260 is not received in concert with the textual electronic document 205, or in the case that an additional textual electronic document from the context database 140 is relevant to responding to the request 260, the engine 270 can identify the one or more relevant textual electronic documents for the request 260 using the database 140. In particular, the similarity evaluator 270 can first determine the document-level similarity 276 between the request embedding(s) 272 to identify relevant textual electronic documents as candidates, and can then identify the document-level embeddings for the candidate textual electronic documents.

For example, the subsystem 200 can use the respective document-level similarity 274 to identify all the contracts with liability clauses in South America and can use the respective sub-document similarity 274 to identify all of the liability clauses that are, e.g., similar or dissimilar, to a particular liability clause included in the document analysis request 260. In particular, in this case, the engine 270 can determine the document-level similarity 276 between the request embedding(s) 272 and the document-level embeddings in order to identify one or more textual electronic documents that are candidate textual electronic documents for the request 260, e.g., contracts with liability clauses in South America. The engine 270 can then determine the sub-document similarity 274 between each of the sub-document embeddings corresponding with the identified candidate textual electronic documents. The sub-document similarity 274 can then be used to identify all the sections of the contracts with liability clauses that are similar to the liability clause in the request 260.

The subsystem 200 can then provide the identified sub-document(s) 280 as the relevant portion(s) of context 152 for the request 260. As depicted with respect to FIG. 1, the system 100 can then provide the identified sub-document(s) 280 as context to at least one of the one or more external LLMs, e.g., by including the sub-document(s) 280 in the input 150.

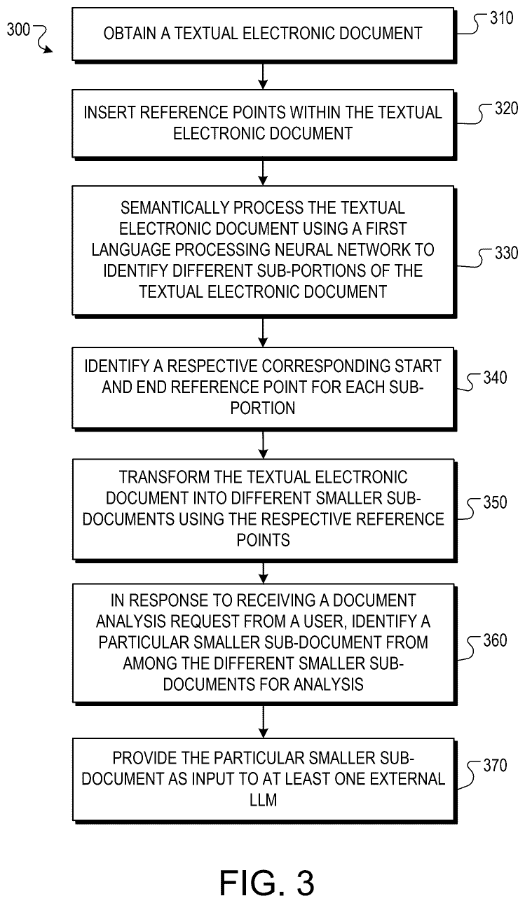

FIG. 3 is a flow diagram of an example process 300 for transforming a textual electronic document into smaller sub-documents for use as context for an LLM. For convenience, the process 300 will be described as being performed by a system of one or more computers located in one or more locations. For example, a LLM request management system, e.g., the LLM request management system 100 of FIG. 1, that is connected between a client device and one or more external large language models (LLMs) and is appropriately programmed in accordance with this specification, can perform the process 300.

As previously discussed, the one or more external LLMs can each be external to the system that performs operations of the process 300. For example, any or all of the one or more external LLMs can be commercially available LLMs that are developed by third parties that differ from the entity providing the system that performs operations of the process 300. The system that performs operations of the process 300 can also include one or more LLMs.

The system can obtain a textual electronic document (step 310), and can insert reference points at different locations within the textual electronic document (step 320). For example, the textual electronic document can be a long-form text file, e.g., a contract, brief, or court case filing. As another example, the textual electronic document can be an essay, technical documentation, an annual report, or a script. In particular, the system can insert line numbers into the textual electronic document as the reference points at different locations.

The system can semantically process the textual electronic document using a first language processing neural network to identify different sub-portions of the textual electronic document (step 330). In particular, the system can process the textual electronic document using the first language processing neural network with an instruction to identify different sub-portions of the textual electronic document that each correspond to a different semantic category among multiple semantic categories, e.g., the different sub-portions can be identified independently of structural boundaries of the textual electronic document.

More specifically, the system can determine the different sub-portions of the textual electronic document independent of structural textual breaks, or other structural boundaries, included in the textual electronic document, e.g., line breaks, paragraph breaks, periods, page breaks, etc. As an example, the semantic categories can include multiple structural boundaries of the textual electronic document, e.g., multiple paragraphs, even across sections, or grouped sections. In particular, the system can identify sections 1-3, 5-6, and section 6 continued as different semantic categories, as opposed to section 1, section 2, section 3, etc. In some cases, the system can additionally determine whether the textual electronic document includes different sub-portions, each corresponding to a different semantic category. In this case, the system can receive an indicator that the textual electronic document includes structured text, or can process the textual electronic document to identify whether the document is structured, e.g., using a textual segmentation model.

In some cases, the system can additionally process each of the identified different sub-portions using the first language processing neural network with an instruction to identify any additional different sub-portions of the identified sub-portion that each correspond to a different semantic category among multiple semantic categories. In particular, the system can process the identified different sub-portion to identify sub-portions of the identified sub-portion, e.g., the identified sub-portion subsumes any additional different sub-portions. For example, the system can iteratively process each of the identified different sub-portions and any additional different sub-portions to determine a hierarchy of sub-portions according to a parent-child relationship between the identified sub-portion and any additional different sub-portions.

The system can identify a corresponding start and end reference point for each sub-portion among the different sub-portions of the textual electronic document (step 340), and can transform the textual electronic document into different smaller sub-documents using the respective reference points (step 350). For example, the system can define the start of the given sub-portion at a first location of the corresponding start reference point and the end of the given sub-portion at a second location of the corresponding end reference point. In particular, each of the multiple different smaller sub-documents can contain text of a given sub-portion, e.g., among the multiple different sub-portions, and can comply with an input size limit of one or more of the external LLMs, e.g., an input context window or length defining the number of input tokens that the LLM can process.

For example, the system can transform the textual electronic document into multiple different smaller sub-documents by linking each given smaller sub-document to data specifying (i) the start reference point and the end reference point of the text of the given smaller sub-document and (ii) a given semantic category of the given smaller sub-document based on the semantic analysis of the text of the given smaller sub-document. In this context, linking data specifying the given semantic category to the given smaller sub-document includes associating a sub-document embedding of the given smaller sub-document, e.g., generated using an embedding neural network, with the given semantic category. As another example, the system can also obtain a document-level embedding representing the textual electronic document, e.g., using the embedding neural network, and can link the textual electronic document and the multiple different smaller sub-documents corresponding with the textual electronic document, e.g., based on a measure of similarity between the document-level embedding and the multiple different smaller sub-document embeddings.

The system can receive a document analysis request from a user, and in response to receiving the document analysis request from a user, the system can then identify a particular smaller sub-document from among the different smaller sub-documents for analysis (step 360). In particular, the system can identify the particular smaller sub-document relevant to the document analysis request by determining respective measures of similarity between one or more request embeddings generated from the document analysis request, e.g., using an embedding neural network, and one or more of (i) the document-level embedding of the textual electronic document, and, for each particular smaller sub-document, (ii) the sub-document embedding of the particular smaller sub-document.

In particular, the system can select at least one smaller sub-document based on the respective measures of similarity. For example, the system can select the at least one smaller sub-document from a database that includes sub-document embeddings using a retriever model. In this case, each sub-document embedding has been generated by processing a respective sub-document from the identified one or more sub-documents, e.g., using the embedding neural network, e.g., by selecting the smaller sub-document with the highest measure of similarity or by selecting the top N smaller sub-documents with the N highest measures of similarity from the database.

In some cases, the database can additionally include the document-level embeddings that correspond with the sub-document embeddings. As an example, the system can identify one or more additional particular sub-documents of two or more additional textual electronic documents using the database for responding to the document analysis request.

In particular, the system can determine a respective first measure of similarity between the one or more request embeddings and each document-level embedding in the database to select one or more candidate textual electronic documents based on the respective first measures of similarity. For each candidate textual electronic document, the system can then determine a respective second measure of similarity between the one or more request embeddings and the sub-document embeddings that correspond with the candidate textual electronic document, and can identify the one or more additional particular smaller sub-documents of two or more additional textual electronic documents based on the respective second measures of similarity.

The system can provide the particular smaller sub-document as input to at least one of the one or more external LLMs (step 370). In the case that the system identifies one or more additional particular smaller sub-documents of two or more additional textual electronic documents, the system can provide the particular smaller sub-document and the one or more additional particular smaller sub-documents as input to the one or more external LLMs.

The system can receive one or more corresponding responses to the document analysis request from the at least one of the one or more external LLMs. For example, the system can use the one or more corresponding responses to perform a task and can provide the results of the completed task to the client device. As another example, in the case that the system identifies and provides multiple smaller sub-documents to the at least one or more external LLMs for responding to the document analysis request, the system can receive an aggregate analysis of the particular smaller sub-document and the one or more additional particular smaller sub-documents from the one or more external LLMs.

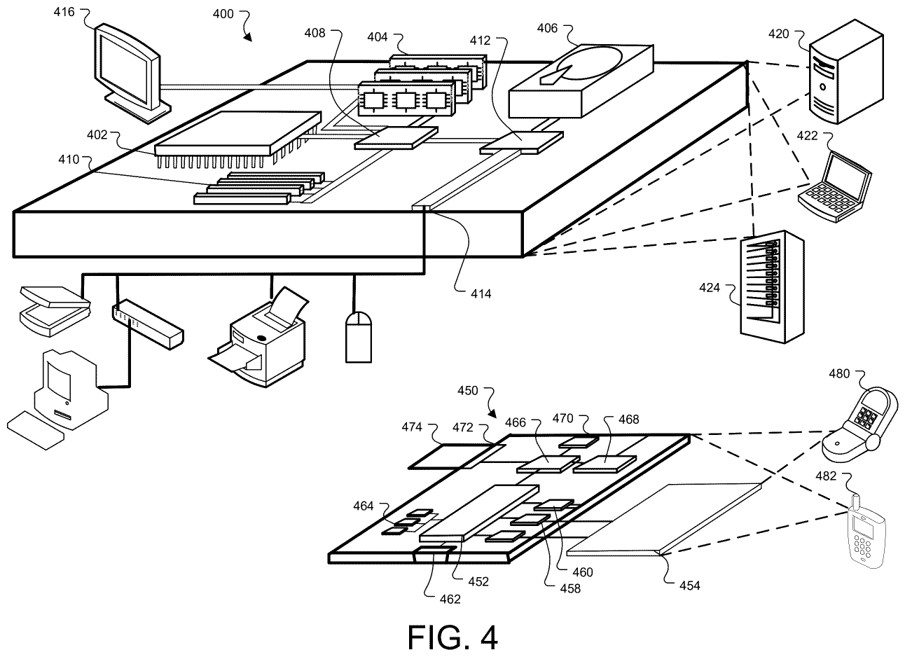

FIG. 4 shows an example of example computer device 400 and example mobile computer device 450, which can be used to implement the techniques described herein. For example, a portion or all of the operations for transforming a textual electronic document into multiple different sub-documents, identifying one or more sub-documents in response to receiving a document analysis request, and providing the identified sub-documents as input to at least one external LLM, etc. may be executed by the computer device 400 and/or the mobile computer device 450. Computing device 400 is intended to represent various forms of digital computers, including, e.g., laptops, desktops, workstations, personal digital assistants, servers, blade servers, mainframes, and other appropriate computers. Computing device 450 is intended to represent various forms of mobile devices, including, e.g., personal digital assistants, tablet computing devices, cellular telephones, smartphones, and other similar computing devices. The components shown here, their connections and relationships, and their functions, are meant to be examples only, and are not meant to limit implementations of the techniques described and/or claimed in this document.

Computing device 400 includes processor 402, memory 404, storage device 406, high-speed interface 408 connecting to memory 404 and high-speed expansion ports 410, and low-speed interface 412 connecting to low-speed bus 414 and storage device 406. Each of components 402, 404, 406, 408, 410, and 412, are interconnected using various busses, and can be mounted on a common motherboard or in other manners as appropriate. Processor 402 can process instructions for execution within computing device 400, including instructions stored in memory 404 or on storage device 406 to display graphical data for a GUI on an external input/output device, including, e.g., display 416 coupled to high-speed interface 408. In other implementations, multiple processors and/or multiple busses can be used, as appropriate, along with multiple memories and types of memory. Also, multiple computing devices 400 can be connected, with each device providing portions of the necessary operations (e.g., as a server bank, a group of blade servers, or a multi-processor system).

Memory 404 stores data within computing device 400. In one implementation, memory 404 is a volatile memory unit or units. In another implementation, memory 404 is a non-volatile memory unit or units. Memory 404 also can be another form of computer-readable medium (e.g., a magnetic or optical disk. Memory 404 may be non-transitory.)

Storage device 406 is capable of providing mass storage for computing device 400. In one implementation, storage device 406 can be or contain a computer-readable medium (e.g., a floppy disk device, a hard disk device, an optical disk device, or a tape device, a flash memory or other similar solid state memory device, or an array of devices, such as devices in a storage area network or other configurations.) A computer program product can be tangibly embodied in a data carrier. The computer program product also can contain instructions that, when executed, perform one or more methods (e.g., those described above.) The data carrier is a computer- or machine-readable medium, (e.g., memory 404, storage device 406, memory on processor 402, and the like.)

High-speed controller 408 manages bandwidth-intensive operations for computing device 400, while low-speed controller 412 manages lower bandwidth-intensive operations. Such allocation of functions is an example only. In one implementation, high-speed controller 408 is coupled to memory 404, display 416 (e.g., through a graphics processor or accelerator), and to high-speed expansion ports 410, which can accept various expansion cards (not shown). In the implementation, low-speed controller 412 is coupled to storage device 406 and low-speed expansion port 414. The low-speed expansion port, which can include various communication ports (e.g., USB, Bluetooth®, Ethernet, wireless Ethernet), can be coupled to one or more input/output devices, (e.g., a keyboard, a pointing device, a scanner, or a networking device including a switch or router, e.g., through a network adapter.)

Computing device 400 can be implemented in a number of different forms, as shown in the figure. For example, it can be implemented as standard server 420, or multiple times in a group of such servers. It also can be implemented as part of rack server system 424. In addition or as an alternative, it can be implemented in a personal computer (e.g., laptop computer 422.) In some examples, components from computing device 400 can be combined with other components in a mobile device (not shown), e.g., device 450. Each of such devices can contain one or more of computing device 400, 450, and an entire system can be made up of multiple computing devices 400, 450 communicating with each other.

Computing device 450 includes processor 452, memory 464, an input/output device (e.g., display 454, communication interface 466, and transceiver 468) among other components. Device 450 also can be provided with a storage device, (e.g., a microdrive or other device) to provide additional storage. Each of components 450, 452, 464, 454, 466, and 468, are interconnected using various buses, and several of the components can be mounted on a common motherboard or in other manners as appropriate.

Processor 452 can execute instructions within computing device 450, including instructions stored in memory 464. The processor can be implemented as a chipset of chips that include separate and multiple analog and digital processors. The processor can provide, for example, for coordination of the other components of device 450, e.g., control of user interfaces, applications run by device 450, and wireless communication by device 450.

Processor 452 can communicate with a user through control interface 458 and display interface 456 coupled to display 454. Display 454 can be, for example, a TFT LCD (Thin-Film-Transistor Liquid Crystal Display) or an OLED (Organic Light Emitting Diode) display, or other appropriate display technology. Display interface 456 can comprise appropriate circuitry for driving display 454 to present graphical and other data to a user. Control interface 458 can receive commands from a user and convert them for submission to processor 452. In addition, external interface 462 can communicate with processor 442, so as to enable near area communication of device 450 with other devices. External interface 462 can provide, for example, for wired communication in some implementations, or for wireless communication in other implementations, and multiple interfaces also can be used.

Memory 464 stores data within computing device 450. Memory 464 can be implemented as one or more of a computer-readable medium or media, a volatile memory unit or units, or a non-volatile memory unit or units. Expansion memory 474 also can be provided and connected to device 450 through expansion interface 472, which can include, for example, a SIMM (Single In Line Memory Module) card interface. Such expansion memory 474 can provide extra storage space for device 450, or also can store applications or other data for device 450. Specifically, expansion memory 474 can include instructions to carry out or supplement the processes described above, and can include secure data also. Thus, for example, expansion memory 474 can be provided as a security module for device 450, and can be programmed with instructions that permit secure use of device 450. In addition, secure applications can be provided through the SIMM cards, along with additional data, (e.g., placing identifying data on the SIMM card in a non-hackable manner.)

The memory 464 can include, for example, flash memory and/or NVRAM memory, as discussed below. In one implementation, a computer program product is tangibly embodied in a data carrier. The computer program product contains instructions that, when executed, perform one or more methods, e.g., those described above. The data carrier is a computer- or machine-readable medium (e.g., memory 464, expansion memory 474, and/or memory on processor 452), which can be received, for example, over transceiver 468 or external interface 462.

Device 450 can communicate wirelessly through communication interface 466, which can include digital signal processing circuitry where necessary. Communication interface 466 can provide for communications under various modes or protocols (e.g., GSM voice calls, SMS, EMS, or MMS messaging, CDMA, TDMA, PDC, WCDMA, CDMA2000, or GPRS, among others.) Such communication can occur, for example, through radio-frequency transceiver 468. In addition, short-range communication can occur, e.g., using a Bluetooth®, WiFi, or other such transceiver (not shown). In addition, GPS (Global Positioning System) receiver module 470 can provide additional navigation- and location-related wireless data to device 450, which can be used as appropriate by applications running on device 450. Sensors and modules such as cameras, microphones, compasses, accelerators (for orientation sensing), etc. may be included in the device.

Device 450 also can communicate audibly using audio codec 460, which can receive spoken data from a user and convert it to usable digital data. Audio codec 460 can likewise generate audible sound for a user, (e.g., through a speaker in a handset of device 450.) Such sound can include sound from voice telephone calls, can include recorded sound (e.g., voice messages, music files, and the like) and also can include sound generated by applications operating on device 450.

Computing device 450 can be implemented in a number of different forms, as shown in the figure. For example, it can be implemented as cellular telephone 480. It also can be implemented as part of smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor. The programmable processor can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a device for displaying data to the user (e.g., a CRT (cathode ray tube) or LCD (liquid crystal display) monitor), and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a backend component (e.g., as a data server), or that includes a middleware component (e.g., an application server), or that includes a frontend component (e.g., a client computer having a user interface or a Web browser through which a user can interact with an implementation of the systems and techniques described here), or a combination of such back end, middleware, or frontend components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A computer-implemented method comprising:
obtaining, by a system that is connected between a client device and one or more external large language models (LLMs) that are each external to the system, a textual electronic document;
inserting, by the system, reference points at different locations within the textual electronic document;
semantically processing the textual electronic document using a first language processing neural network with an instruction to identify different sub-portions of the textual electronic document that each correspond to a different semantic category among multiple semantic categories, wherein the semantic processing is performed independent of structural boundaries of the textual electronic document;
identifying, by the system and for each given sub-portion among the different sub-portions of the textual electronic document, a corresponding start reference point and a corresponding end reference point from among the inserted reference points, wherein a start of the given sub-portion is at a first location of the corresponding start reference point, and an end of the given sub-portion is a second location of the corresponding end reference point;
transforming, by the system, the textual electronic document into multiple different smaller sub-documents, wherein each given smaller sub-document contains text of a given sub-portion among the multiple different sub-portions, and wherein each of the multiple different smaller sub-documents complies with an input size limit of the one or more external LLMs;
receiving a document analysis request from the client device; and
in response to receiving the document analysis request from the client device:
identifying a particular smaller sub-document from among the multiple different smaller sub-documents for analysis; and
providing the particular smaller sub-document as input to at least one of the one or more external LLMs.

2. The computer-implemented method of claim 1, further comprising:
in response to receiving the document analysis request from the client device:
identifying one or more additional particular smaller sub-documents of two or more additional textual electronic documents;
providing the one or more additional particular smaller sub-documents of two or more additional textual electronic documents as input to at least one of the one or more external LLMs; and
receiving, from the one or more external LLMs, an aggregate analysis of the particular smaller sub-document and the one or more additional particular smaller sub-documents.

3. The computer-implemented method of claim 1, wherein semantically processing the textual electronic document further comprises, for each identified different sub-portion:
processing the identified sub-portion using the first language processing neural network with an instruction to identify any additional different sub-portions of the identified sub-portion that each correspond to a different semantic category among multiple semantic categories.

4. The computer-implemented method of claim 1, wherein transforming, by the system, the textual electronic document into multiple different smaller sub-documents comprises, for each given smaller sub-document, linking the given smaller sub-document and data specifying (i) the start reference point and the end reference point of the text of the given smaller sub-document and (ii) a given semantic category of the given smaller sub-document based on the semantic analysis of the text of the given smaller sub-document.

5. The computer-implemented method of claim 4, wherein linking data specifying the given semantic category to the given smaller sub-document comprises associating a sub-document embedding of the given smaller sub-document with the given semantic category.

6. The computer-implemented method of claim 5, further comprising:
obtaining a document-level embedding representing the textual electronic document; and
linking the textual electronic document and the multiple different smaller sub-documents corresponding with the textual electronic document based on a measure of similarity between the document-level embedding and the sub-document embeddings.

7. The computer-implemented method of claim 6, wherein identifying a particular smaller sub-document from among the multiple different smaller sub-documents for analysis comprises:
determining respective measures of similarity between one or more request embeddings generated from the document analysis request and one or more of (i) the document-level embedding of the textual electronic document and, for each particular smaller sub-document, (ii) the sub-document embedding of the particular smaller sub-document.

8. The computer-implemented method of claim 7, further comprising:
selecting at least one smaller sub-document based at least on the respective measures of similarity.

9. The computer-implemented method of claim 8, wherein the at least one smaller sub-document is selected from a database comprising sub-document embeddings using a retriever model, and wherein each sub-document embedding has been generated by processing a respective sub-document from the identified one or more sub-documents using an embedding neural network.

10. The computer-implemented method of claim 9, further comprising, identifying one or more additional particular smaller sub-documents of two or more additional textual electronic documents in response to receiving the document analysis request, wherein identifying the one or more additional particular sub-documents comprises:
determining a respective first measure of similarity between the one or more request embeddings and each document-level embedding in the database;
selecting one or more candidate textual electronic documents based on the respective first measures of similarity;
for each candidate textual electronic document, determining respective second measures of similarity between the one or more request embeddings and each sub-document embedding corresponding with the candidate textual electronic document; and
identifying the one or more additional particular smaller sub-documents of two or more additional textual electronic documents based on the respective second measures of similarity.

11. The computer-implemented method of claim 1, further comprising:
receiving one or more corresponding responses to the document analysis request from the at least one of the one or more external LLMs.

12. The computer-implemented method of claim 11, further comprising:
using the one or more corresponding responses to perform a task; and
providing results of the task to the client device.

13. A system comprising one or more computers and one or more storage devices storing instructions that are operable, when executed by the one or more computers, to cause the one or more computers to perform operations comprising:
obtaining, by a system that is connected between a client device and one or more external large language models (LLMs) that are each external to the system, a textual electronic document;
inserting, by the system, reference points at different locations within the textual electronic document;
semantically processing the textual electronic document using a first language processing neural network with an instruction to identify different sub-portions of the textual electronic document that each correspond to a different semantic category among multiple semantic categories, wherein the semantic processing is performed independent of structural boundaries of the textual electronic document;
identifying, by the system and for each given sub-portion among the different sub-portions of the textual electronic document, a corresponding start reference point and a corresponding end reference point from among the inserted reference points, wherein a start of the given sub-portion is at a first location of the corresponding start reference point, and an end of the given sub-portion is a second location of the corresponding end reference point;
transforming, by the system, the textual electronic document into multiple different smaller sub-documents, wherein each given smaller sub-document contains text of a given sub-portion among the multiple different sub-portions, and wherein each of the multiple different smaller sub-documents complies with an input size limit of the one or more external LLMs;
receiving a document analysis request from the client device; and
in response to receiving the document analysis request from the client device:
identifying a particular smaller sub-document from among the multiple different smaller sub-documents for analysis; and
providing the particular smaller sub-document as input to at least one of the one or more external LLMs.

14. The system of claim 13, wherein the operations further comprise:
in response to receiving the document analysis request from the client device:
identifying one or more additional particular smaller sub-documents of two or more additional textual electronic documents;
providing the one or more additional particular smaller sub-documents of two or more additional textual electronic documents as input to at least one of the one or more external LLMs; and
receiving, from the one or more external LLMs, an aggregate analysis of the particular smaller sub-document and the one or more additional particular smaller sub-documents.

15. The system of claim 13, wherein semantically processing the textual electronic document further comprises, for each identified different sub-portion:
processing the identified sub-portion using the first language processing neural network with an instruction to identify any additional different sub-portions of the identified sub-portion that each correspond to a different semantic category among multiple semantic categories.

16. The system of claim 13, wherein transforming, by the system, the textual electronic document into multiple different smaller sub-documents comprises, for each given smaller sub-document, linking the given smaller sub-document and data specifying (i) the start reference point and the end reference point of the text of the given smaller sub-document and (ii) a given semantic category of the given smaller sub-document based on the semantic analysis of the text of the given smaller sub-document.

17. A computer storage medium encoded with a computer program, the program comprising instructions that are operable, when executed by data processing apparatus, to cause the data processing apparatus to perform operations comprising:
obtaining, by a system that is connected between a client device and one or more external large language models (LLMs) that are each external to the system, a textual electronic document;
inserting, by the system, reference points at different locations within the textual electronic document;
semantically processing the textual electronic document using a first language processing neural network with an instruction to identify different sub-portions of the textual electronic document that each correspond to a different semantic category among multiple semantic categories, wherein the semantic processing is performed independent of structural boundaries of the textual electronic document;
identifying, by the system and for each given sub-portion among the different sub-portions of the textual electronic document, a corresponding start reference point and a corresponding end reference point from among the inserted reference points, wherein a start of the given sub-portion is at a first location of the corresponding start reference point, and an end of the given sub-portion is a second location of the corresponding end reference point;
transforming, by the system, the textual electronic document into multiple different smaller sub-documents, wherein each given smaller sub-document contains text of a given sub-portion among the multiple different sub-portions, and wherein each of the multiple different smaller sub-documents complies with an input size limit of the one or more external LLMs;
receiving a document analysis request from the client device; and
in response to receiving the document analysis request from the client device:
identifying a particular smaller sub-document from among the multiple different smaller sub-documents for analysis; and
providing the particular smaller sub-document as input to at least one of the one or more external LLMs.

18. The computer storage medium of claim 17, wherein the operations further comprise:
in response to receiving the document analysis request from the client device:
identifying one or more additional particular smaller sub-documents of two or more additional textual electronic documents;
providing the one or more additional particular smaller sub-documents of two or more additional textual electronic documents as input to at least one of the one or more external LLMs; and
receiving, from the one or more external LLMs, an aggregate analysis of the particular smaller sub-document and the one or more additional particular smaller sub-documents.

19. The computer storage medium of claim 17, wherein semantically processing the textual electronic document further comprises, for each identified different sub-portion:
processing the identified sub-portion using the first language processing neural network with an instruction to identify any additional different sub-portions of the identified sub-portion that each correspond to a different semantic category among multiple semantic categories.

20. The computer storage medium of claim 17, wherein transforming, by the system, the textual electronic document into multiple different smaller sub-documents comprises, for each given smaller sub-document, linking the given smaller sub-document and data specifying (i) the start reference point and the end reference point of the text of the given smaller sub-document and (ii) a given semantic category of the given smaller sub-document based on the semantic analysis of the text of the given smaller sub-document.
